(19) United States
(12) Patent Application Publication
(10) Pub. No.: US 2011/0102687 A1
(43) Pub. Date: May 5, 2011

(54) LCM FOR A DISPLAY PANEL

(75) Inventors: Man Jeong Ko, Daejeon-si (KR); Joon Ho Na, Daejeon-si (KR); Dae Seong Kim, Daejeon-si (KR); Dae Keun Han, Daejeon-si (KR)

(73) Assignee: SILICON WORKS CO., LTD, Daejeon-si (KR)

(21) Appl. No.: 13/002,850

(22) PCT Filed: Jun. 23, 2009
(86) PCT No.: PCT/KR2009/003354

§ 371 Date: Jan. 6, 2011

(30) Foreign Application Priority Data
Jul. 24, 2008 (KR) 10-2008-0072013

(51) Int. Cl. H04N 3/14

(52) U.S. Cl. 348/790; 348/E03.016

(57) ABSTRACT

An LCM for a display panel includes a pixel array, a plurality of source driver ICs, and a plurality of gate driver ICs. The plurality of source driver ICs are disposed in a horizontal direction at an upper side or lower side of the pixel array. The plurality of gate driver ICs are disposed in a vertical direction at a left side or right side of the pixel array. The plurality of gate driver ICs are disposed at an opposite position to a position where a source driver IC, among the plurality of source driver ICs, first supplied with video data and a clock signal is disposed.

### BACKGROUND OF THE INVENTION

1. Field of the Invention

The present invention relates to a liquid crystal module (LCM) for a display panel, and more particularly, to an LCM for a display panel which can maximize efficiency in panel design.

2. Description of the Related Art

FIG. 1 is a view illustrating a conventional chip-on-glass (COG) type liquid crystal module (LCM).

Referring to FIG. 1, a COG-type LCM for a display panel includes a display panel 120, an FPC 130, and a timing controller 140.

The display panel 120 includes a pixel array 110, and source driver ICs SD1 through SD8 and gate driver ICs GD1 and GD2 for driving the pixel array 110. Power PSD for source drivers and power PGD for gate drivers are applied to the source driver ICs SD1 through SD8 and the gate driver ICs GD1 and GD2, respectively, from the FPC 130. Among signals DATA/CLK, GAM/CON, and CON related to the display of the pixel array 110, the source driver IC-related signals DATA/CLK and GAM/CON pass through the timing controller 140 and the FPC 130, pass through the source driver ICs SD1 through SD8 in the sequence from the first source driver IC SD1 disposed on the left side in a lower part of the display panel 120 to source driver ICs SD2 through SD8 continuously arranged to the right of the first source driver IC SD1, and are then applied to the pixel array 110. The gate driver IC-related signal CON is applied to the gate driver ICs GD1 and GD2 disposed on the left side of the display panel 120, and drives the pixel array 110.

In detail, the video data DATA for source driver ICs and the clock signal CLK for source driver ICs are applied to the first source driver IC SD1. The second source driver IC SD2 does not receive video data and a clock signal DATA/CLK directly from the FPC 130, and uses a signal outputted from the first source driver IC SD1 as video data and a clock signal DATA/CLK. Similarly, the third source driver IC SD3 uses a signal outputted from the second source driver IC SD2, which is located in front of the third source driver IC SD3, as video data and a clock signal DATA/CLK. That is to say, in the case of the source driver ICs, video data and a clock signal DATA/CLK, which are inputted to the first source driver IC SD1 via the timing controller 140 and the FPC 130, are transferred to the plurality of serially arranged source driver ICs SD1 through SD8 in a cascade scheme.

The gamma signal GAM and control signal CON related to the source driver ICs SD1 through SD8 are connected in parallel directly to the source driver ICs SD1 through SD8. The control signal CON related to gate driver ICs are supplied to the plurality of gate driver ICs GD1 and GD2 in a cascade scheme.

As described above, since the video data and the clock signal DATA/CLK are received first by the first source driver IC SD1 disposed on the left side of the pixel array 110, and the gate driver ICs driving the pixel array in combination with the source driver ICs are also disposed on the left side of the display panel, a great number of lines-on-glass (LOGS) exist between a corner of the display panel and the source driver ICs (see a dotted ellipse).

That is to say, referring to FIG. 1, k (wherein k is an integer) number of lines for video data and a clock signal DATA/CLK applied to the source driver ICs SD1 through SD8, l (wherein l is an integer) number of lines for gamma and control signals GAM/CON, and m (wherein m is an integer) number of lines for a control signal CON applied to the gate driver ICs GD1 and GD2 are laid out in parallel to one another within the dotted ellipse. LOG-type metal lines not only have a fixed width, but also require a fixed space between them so as to be electrically isolated from neighboring metal lines.

As a consequence, due to the fact that the LOG-type metal lines are disposed between the FPC and the source driver ICs disposed on the lower part of the display panel, disadvantages are caused in that, as the number of the metal lines disposed in parallel increases, the overall area of the display panel system increases.

### SUMMARY OF THE INVENTION

Accordingly, the present invention has been made in an effort to solve the problems occurring in the related art, and an object of the present invention is to provide a liquid crystal module (LCM) for a display panel for maximizing the efficiency in the panel design and reducing the entire area thereof.

In order to achieve the above object, according to one aspect of the present invention, there is provided an LCM for a display panel, which includes a pixel array, a plurality of source driver ICs, and a plurality of gate driver ICs. The plurality of source driver ICs are disposed in a horizontal direction at an upper side or lower side of the pixel array. The plurality of gate driver ICs are disposed in a vertical direction at a left side or right side of the pixel array. The plurality of gate driver ICs are disposed at an opposite position to a position where a source driver IC, among the plurality of source driver ICs, first supplied with video data and a clock signal is disposed.

### BRIEF DESCRIPTION OF THE DRAWINGS

The above objects, and other features and advantages of the present invention will become more apparent after a reading of the following detailed description taken in conjunction with the drawings, in which:

FIG. 1 is a view illustrating a conventional COG-type LCM; and

FIG. 2 is a view illustrating a part of the layout of an LCM for a display panel in accordance with an embodiment of the present invention.

### DETAILED DESCRIPTION OF PREFERRED EMBODIMENT

Reference will now be made in greater detail to a preferred embodiment of the invention, an example of which is illustrated in the accompanying drawings. Wherever possible, the same reference numerals will be used throughout the drawings and the description to refer to the same or like parts.

FIG. 2 is a view illustrating a part of the layout of a liquid crystal module (LCM) for a display panel in accordance with an embodiment of the present invention.

Referring to FIG. 2, an LCM 200 for a display panel includes a display panel 220, FPCs 230 and 240, and a timing controller 250.

The display panel 220 includes a pixel array 210, and includes source driver ICs SD1 to SD8 and gate driver ICs GD1 and GD2 for driving the pixel array 210. Power PSD for source drivers and power PGD for gate drivers are applied to the source driver ICs SD1 to SD8 and the gate driver ICs GD1 and GD2, respectively, from the FPCs 230 and 240. Among signals DATA/CLK, GAM/CON, and CON related to the display of the pixel array 210, the source driver IC-related signals DATA/CLK and GAM/CON pass through the timing controller 250 and the FPC 230, pass through the source driver ICs SD1 to SD8 in the sequence from the first source driver IC SD1 disposed on the left side in a lower part of the display panel 220 to source driver ICs SD2 to SD8 continuously arranged to the right of the first source driver IC SD1, and are then applied to the pixel array 210. The gate driver IC-related signal CON is applied to the gate driver ICs GD1 and GD2 disposed on the left side of the display panel 220, and drives the pixel array 210.

As described above, in the prior art, most of signals applied to source driver ICs are supplied from the left side of a display panel, and gate driver ICs controlling the vertical direction of the display panel are disposed on the left side of the display panel, too. Accordingly, since metal lines which are transmission/reception paths of signals for the two types of driver ICs are concentrated on one side, i.e. on the left side of the display panel, a large space is required on the left lower part of the display panel. In contrast, it is inevitable to cause a large empty space on the right lower part of the display panel in order to accord with the left space increasing in the vertical lower direction.

According to the present invention, as shown in FIG. 2, the gate driver ICs are disposed on the right side of the display panel, and thus the metal lines, which are signal supply paths for driver ICS, are dispersed, so that it is possible to reduce the layout consumed for an LCM for a display panel. In addition, the present invention has effects in that it is possible to ensure the symmetry between transferred data, and also it is possible to minimize cross-talk between data signals simultaneously transferred in parallel.

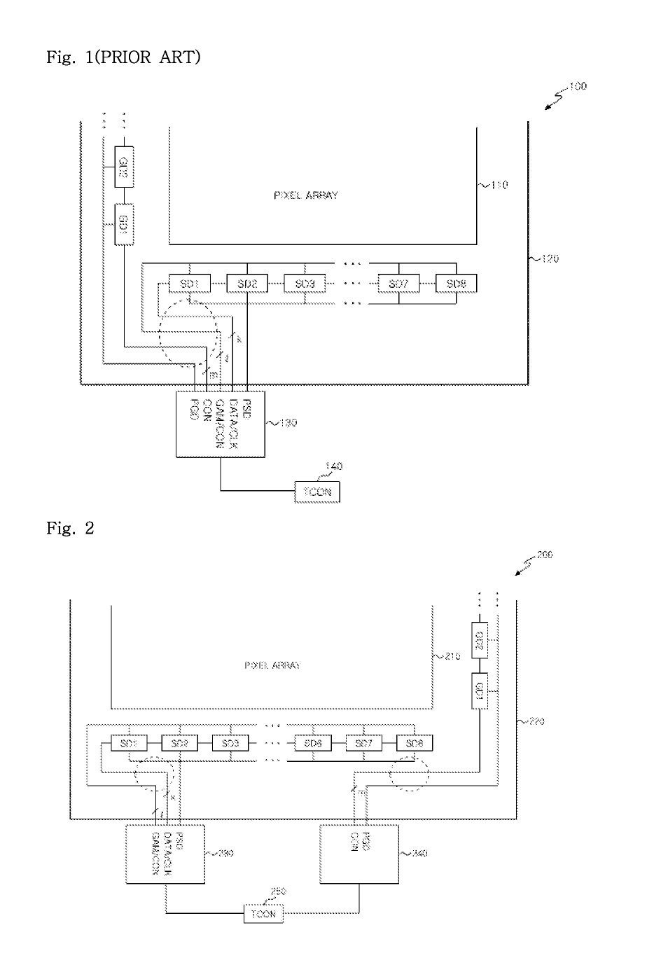

Referring to FIG. 2, according to the present invention, a place (see a dotted circle on the left side) where metal lines supplied for source driver ICs are disposed, and a place (see a dotted circle on the right side) where metal lines supplied for gate driver ICs are disposed are separated from each other, and a space (e.g. a right space in FIG. 1), which has not been used in the prior art, is utilized, so that it is possible to increase space use efficiency, and also it is possible to reduce the entire layout.

Although it is normal that signals for source driver ICs are supplied first to a source driver IC disposed on the most left side, and the supplied signals are transferred to the other source driver ICs disposed on the right side in the cascade scheme, the signals may be transferred from the right side to the left side. In this case, the configuration of the present invention has only to be modified in such a manner as to dispose gate driver ICs on the left side of the display panel, and to drive metal lines for supplying signals to source driver ICs from the right side, not from the left side. Although two FPCs 230 and 240 are illustrated in FIG. 2, the present invention may be implemented by means of either one FPC, or more than two FPCs.

Although it is not clearly shown in the drawing, power and display-related signals are transferred to corresponding driver ICs via one or more FPCs through Lines on Glass (LOGs). In addition, although FIGS. 1 and 2 show that gamma and control signals GAM/CON applied to source driver ICs are supplied in the form of a bus, actually, each signal is received directly from a corresponding FPC. Accordingly, because of such characteristics, the relative importance of the metal lines held in layout increases more.

Although FIG. 2 shows that source driver ICs are disposed at the lower side of the pixel array, the source driver ICs may be disposed at the upper side of the pixel array.

According to the present invention, which is suitable for the case of applying the COG technology for installing a chip on the upper surface of a glass substrate to an LCM, the entire of a part of metal lines, carrying power and the entire or a part of control signals supplied to the source driver ICs and gate driver ICs, are dispersed, so that the efficiency in the panel design is maximized in whole.

As is apparent from the above description, the present invention provides advantages in that efficiency is maximized in the panel design of an LCM for a display panel and an overall area is decreased.

Although a preferred embodiment of the present invention has been described for illustrative purposes, those skilled in the art will appreciate that various modifications, additions and substitutions are possible, without departing from the scope and the spirit of the invention as disclosed in the accompanying claims.

1. A liquid crystal module (LCM) for a display panel, comprising:
a pixel array;
a plurality of source driver ICs disposed in a horizontal direction at an upper side or lower side of the pixel array; and
a plurality of gate driver ICs disposed in a vertical direction at a left side or right side of the pixel array,
wherein the plurality of gate driver ICs are disposed at an opposite position to a position where a source driver IC, among the plurality of source driver ICs, first supplied with video data and a clock signal is disposed.

2. The LCM according to claim 1, further comprising:
at least on FPC for supplying power and a display-related signal to the plurality of source driver ICs and the plurality of gate driver ICs.

3. The LCM according to claim 2, further comprising:
a timing controller for supplying the display-related signal to the FPC.

4. The LCM according to claim 2, wherein the power and the display-related signal are transferred through a Line on Glass (LOG).

5. The LCM according to claim 3, wherein the power and the display-related signal are transferred through a Line on Glass (LOG).
